(19) United States
(12) Patent Application Publication
(10) Pub. No.: US 2006/0285268 A1
(43) Pub. Date: Dec. 21, 2006

(54) Electrostatic discharge apparatus for a treadmill

(76) Inventor: Leao Wang, Taiping (TW)

Correspondence Address: Troxell Law Office, PLLC, 5205 Leesburg Pike, Suite 1404, Falls Church, VA, 22041, US

(21) Appl. No.: 11/155,865

(22) Filed: Jun. 20, 2005

(51) Int. Cl. H05F 3/00

(52) U.S. Cl. 361/221

(57) ABSTRACT

An electrostatic discharge apparatus for a treadmill having at least one conductive brush unit in constant contact with front and rear rollers. The conductive brush unit is mounted on a platform frame in close vicinity to the rollers of the continuous moving belt, and the conductive brush unit operates in cooperation with an earth wire to discharge the whole static electricity produced during the operation of the treadmill. In this way, a smooth operation of the treadmill and the relevant electronic elements can be ensured.

### BACKGROUND OF THE INVENTION

1. Fields of the Invention

The invention relates to an electrostatic discharge apparatus for a treadmill, and more particularly, to an electrostatic discharge apparatus that directly removes static electricity from front and rear rollers for the continuous moving belt.

2. Description of the Related Art

The basic operating principle of a treadmill is that a front and a rear roller are utilized to allow a continuous moving belt to rotate around them. In this way, operators can make an in-place walking or jogging exercise on the continuous moving belt. However, the static electricity will be produced and stored in the treadmill during the frictional rotation. If the static electricity produced is not properly eliminated, it would cause damage to a motor, a console, and other electronic components. The manufacturers of the treadmill need to take this problem into account.

At present, the manufacturers utilize an earth wire mounted on the platform frame of the treadmill to discharge the static electricity. However, the discharge effect leaves much to be desired. Particularly, the electronic components of the treadmill are prone to operating trouble. This is required to be eliminated.

### SUMMARY OF THE INVENTION

Thus, based on various empirical studies, the designer found that the above-mentioned problem is because static electricity is left within the front and rear rollers so that the operation of the relevant electronic elements is affected to a great extent. So, the primary object of the invention is to provide at least one conductive brush unit in constant contact with front and rear rollers. The conductive brush unit is mounted on a platform frame in close vicinity to the rollers of the continuous moving belt, and the conductive brush unit operates in cooperation with an earth wire to discharge the whole static electricity produced during the operation of the treadmill.

### BRIEF DESCRIPTION OF THE DRAWINGS

The accomplishment of this and other objects of the invention will become apparent from the following description and its accompanying drawings of which:

FIG. 1 is a perspective assembly view of an application example of a conductive brush unit in accordance with the invention;

FIG. 2 is a partially enlarged section from FIG. 1;

FIG. 3 is a schematic drawing of the conductive brush unit mounted on a platform frame of a treadmill;

FIG. 4 is a perspective view of the conductive brush in accordance with the invention; and

FIG. 5 is a perspective view of the conductive brush in accordance with the invention shown in a position before assembly.

### DETAILED DESCRIPTION OF THE PREFERRED EMBODIMENT

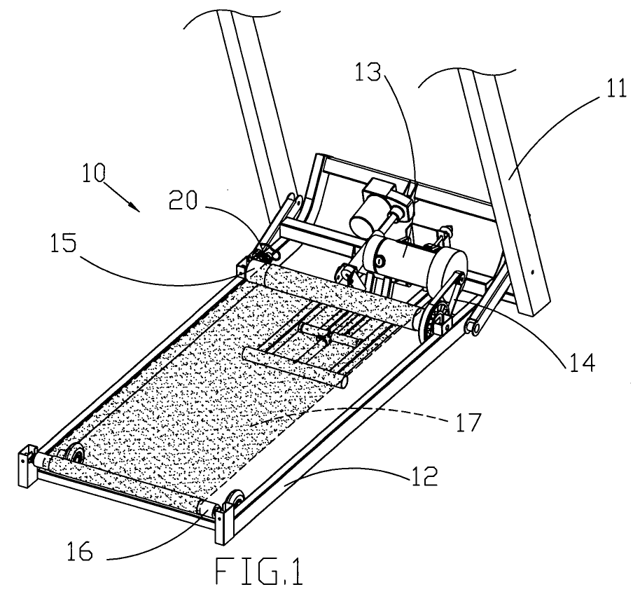

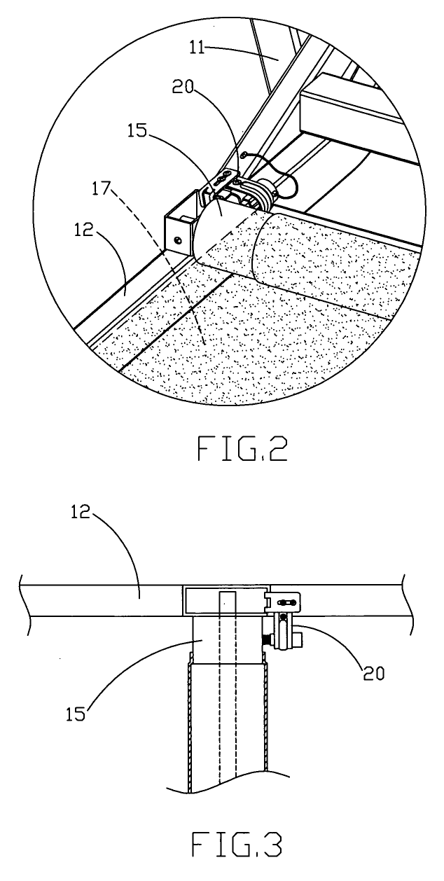

Referring to FIGS. 1, 2 and 3, a treadmill 10 in accordance with the invention includes two handle frames 11 and a platform frame 12. A continuous moving belt 17 shown in broken line operates in cooperation with a motor 13, a belt 14, a front roller 15, and a rear roller 16 to allow it to move on a certain circulation course.

At least one conductive brush unit 20 in constant contact with the front and rear rollers 15 and 16 is mounted on one side rail of the platform frame 12. The conductive brush unit 20 operates in cooperation with an earth wire 30 to discharge a great deal of the static electricity produced during the operation of the treadmill. In this way, a smooth operation of the treadmill and the relevant electronic elements can be ensured.

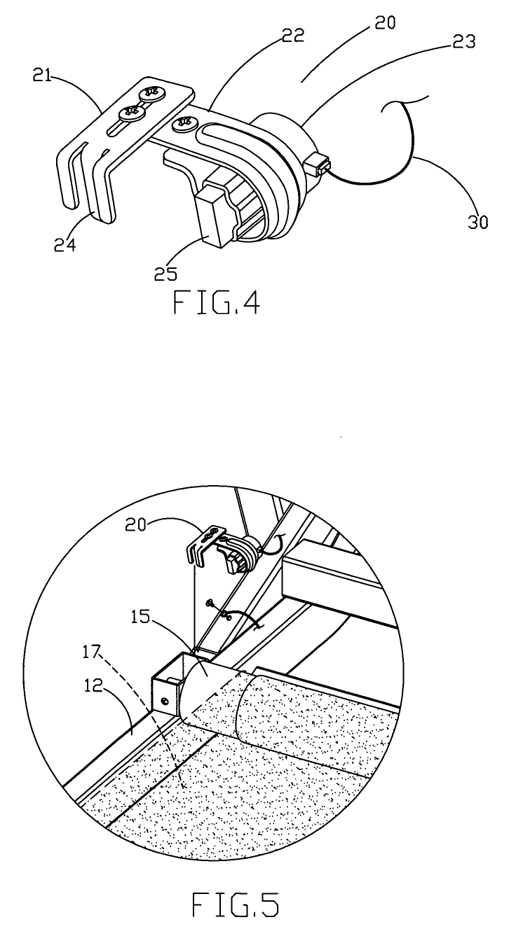

As shown in FIGS. 4 and 5, the conductive brush unit 20 consists of a positioning portion 21, a clamping portion 22, and a brush body 23. The positioning portion 21 includes a clamping arm 24 for securing the conductive brush unit 20 to a side wall of the platform frame 12 in close vicinity to the front and rear rollers 15, 16. The brush body 23 is retained by the clamping portion 22 with its contact end 25 constantly resting against a portion of the front and rear rollers 15, 16 that is not covered by continuous moving belt 17. In this way, the whole static electricity can be effectively discharged out of the treadmill 10 by use of the earth wire 30 coupled to the brush body 23.

The conductive brush unit 20 can be mounted at will on the front and rear rollers 15, 16 in accordance with the available space and different requirements. Even, the front and rear rollers 15, 16 can include corresponding conductive brush units 20 for an enhanced effect with respect to electrostatic discharge. This refers to the application of an easy assembly so that no further descriptions are given hereinafter.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

1-2. (canceled)

3. An electrostatic discharge apparatus for a treadmill having to handles, a platform frame, a continuous moving belt operated by a motor, a belt, a front roller, and a rear roller, the electrostatic discharge apparatus comprising:
a) at least one conductive brush unit connected to a side rail of the platform frame and having:
I) a brush body having a contact end engaging a roller connected to the continuous moving belt and selected from a group consisting of the front roller and the rear roller; and
ii) a clamping portion connected to the brush body; and
b) a ground wire electrically connecting the brush body to the treadmill and discharging a static electricity received from the brush body.

4. The electrostatic discharge apparatus according to claim 3, wherein each at least one conductive brush unit has a positioning portion connected to the clamping portion at a first end thereof and to the side rail of the platform frame at a second end thereof.

5. The electrostatic discharge apparatus according to claim 3, wherein the clamping portion surrounding an exterior periphery of the brush body.
